(19) United States
(12) Patent Application Publication
(10) Pub. No.: US 2024/0333669 A1
(43) Pub. Date: Oct. 3, 2024

(54) EFFECTIVE COMMUNICATION DECISION CLASSIFIER

(71) Applicant: International Business Machines Corporation, Armonk, NY (US)

(72) Inventors: EDGAR SU SU-CHOUG, Tlajomulco de Zuñiga (MX); KASIA KARIMEE GARCIA BRACHO, Guadalajara (MX); Marcos Alejandro Castillo Rivas, Tonala (MX); Steven Lee Fisher-Stawinski, Buffalo Grove, IL (US)

(21) Appl. No.: 18/126,951

(22) Filed: Mar. 27, 2023

(51) Int. Cl. H04L 51/063; G06Q 10/107; H04L 51/214; H04L 51/234

(52) U.S. Cl. CPC H04L 51/063; G06Q 10/107; H04L 51/214; H04L 51/234

(57) ABSTRACT

The method provides for receiving a draft message that includes recipients of the draft message, content of the draft message, and zero of more attachments included with the message, from a sending user. A pre-determined number of properties are determined from the draft message, which include information about the sending user, the recipients of the draft message, a subject and content of the draft message, and a sentiment of the draft message. The draft message properties are submitted to a pre-trained classifier model trained by supervised machine learning techniques to recommend whether a meeting held with the recipients or a delivered communication to the recipients is recommended for the draft message, and responsive to receiving a recommendation of a draft meeting with the recipients from the classifier model, presenting the recommendation of a meeting with the recipients to the sending user.

### BACKGROUND

The present invention relates to facilitating communication, and more specifically to utilizing a trained classifier model to recommend whether the subject and content of a draft message is best handled as a meeting or as a delivered communication.

Communication is an important aspect of the performance and efficiency of teams. Modes and methods of communication have grown to where decisions regarding the more effective means of communication can affect the successful achievement of work goals, including schedule, quality, and resources. Communications made by email are convenient and can reach recipients quickly, and often emails involve multiple responses and responses to responses. Communications can also be delivered by text messages, phone calls, or even by meetings that can be face-to-face, or utilize online applications for virtual meetings.

### SUMMARY

According to an embodiment of the present invention, a computer-implemented method, computer program product, and computer system are provided for a processor to receive from a sending user, a draft message intended for at least one recipient. The processor extracts at least one property of the draft message. The processor submits the draft message properties to a classifier model, which is pre-trained to recommend whether a scheduled synchronous meeting with the at least one recipient will be more effective to address the draft message, and responsive to receiving a recommendation of a draft meeting with the recipients from the pre-trained classified, the processor presents to the sending user the recommendation that the draft message should be directed to a meeting with the recipients.

### BRIEF DESCRIPTION OF THE DRAWINGS

FIG. 1 is a functional block diagram illustrating a distributed data processing environment, in accordance with an embodiment of the present invention.

FIG. 2 is a flowchart depicting the operational steps of a communication classifier program, in accordance with embodiments of the present invention.

FIG. 3 depicts a block diagram of components of a computing system, including a computing device configured to operationally perform the communication classifier program of FIG. 2, in accordance with an embodiment of the present invention.

### DETAILED DESCRIPTION

Embodiments of the present invention recognize that different approaches to collaborative work sometimes leads to deficiencies in organization and communication. Working in teams in which work products may be divided up among team members with timing dependencies and functional coordination often determines the success or failure of the team's objectives. Embodiments of the present invention recognize that communication plays a significant role among collaborative workers, however, decisions as to the mode of communication (i.e., email, text message, person-to-person meeting) to use for achieving the best results do not often receive adequate consideration, or worse, is simply based on assumptions and the convenience of the sender.

Embodiments of the present invention recognize that communicating by email is convenient and can connect quickly with recipients, but the complexity of information, lack of clarity within the email, or responses to the email among multiple recipients can create a web of email follow-ups that become difficult to follow, can raise additional issues resulting in more emails, and fails to accomplish the purpose of the email message. Conversely, embodiments of the present invention recognize that in-person and online conference meetings are scheduled and held, often lengthy in duration and consuming the time of multiple individuals to resolve an issue or problem that could easily be handled by an email, phone call, or possibly text messages. In many cases, the choice of the mode or the means of communication is poorly decided, and often reflects convenience.

Embodiments of the present invention provide a computer-implemented method, computer program product, and computer system for a trained classifier model recommending whether the subject and content of a draft message is more appropriately addressed as a meeting as opposed to a delivered communication, based on properties of the draft message. Embodiments of the present invention train a classifier model as a component module of a communication classifier program. In some embodiments, the classifier model is trained from a corpus of draft messages labeled by experts in collaborative work and communication effectiveness, and historical communications including information about the recipients and sending users associated with the draft message. In some embodiments, the training data are applied to supervised machine learning techniques. In some embodiments, the classifier model is further trained by the use of unsupervised machine learning techniques.

The classifier model is programmed to receive extracted properties of the draft message and using natural language processing and semantic analysis identifies various properties of the draft message, such as but not limited to identifying the sending user and intended recipients, the subject of the draft message, concepts within the content, presence of attachments, length of the draft message, number and length of the attachments, the file type of at least one attachment, message history of the sending user and one or more recipients, organizational relationships of the sending user and intended recipients (hereafter, “recipients”), job function of one or more of the sending user and recipients, and sentiment of the draft message. The training data includes combinations of extracted properties and labeling by experts in collaborative work and communication effectiveness, or a plurality of messages labeled by a set of message recipients that have demonstrated skills in collaboration and work efficiency, for supervised machine learning. The classifier model is trained to recommend, or not recommend, a scheduled person-to-person meeting to address the draft message based on rules learned by the supervised machine learning as applied to combinations of the extracted properties.

For example, the classifier model may receive a draft message determined to have 8 recipients, a subject with a common history with the sending user, and 4 of the 8 recipients, a lengthy message with multiple concepts and two attachments. The trained classifier model may recommend scheduling a person-to-person meeting to address the draft message. In another example, a draft message to 2 recipients with a short length of content that includes two questions, with no attachments may produce a recommendation from the classifier model to not schedule a person-to-person meeting to address the subject and content of the draft message but to deliver the message in an electronic one-party communication, such as an email. In yet another example, the classifier model may recommend scheduling a person-to-person meeting to address a received draft message that includes 3 recipients and has limited content with no attachments due to an organizational relationship between the sending user and two of the recipients and a message history with a common subject (i.e., unresolved items).

An aspect of the invention includes identifying properties of the draft message that are analyzed by the classifier model and used in the determination of a recommendation of whether to address or handle the draft message by scheduling and holding a meeting with the intended recipients of the draft message or by a communication delivery, such as an email or one or more text messages. The action terms of “to address” and “to handle” and their respective variations, as used herein, refer to meeting activities that may include, but are not limited to one or a combination of discussion, collaboration, analysis, clarification, planning, scheduling, brainstorming, back-and-forth exchange, correcting, assigning, and performing actions. In some embodiments, the properties of the draft message include information about the sending user (i.e., draft message author), information about the intended recipients of the draft message, a subject of the draft message, the content of the draft message, and a sentiment of the draft message. In some embodiments, the properties of the draft message also include historic communication regarding the draft message subject or content with respective intended recipients of the draft message, attachments included with the draft message, the organizational relationship between the sending user and the respective intended recipients of the draft message, job function of respective intended recipients of the draft message and the sending user, the length of the draft message, and one or more concepts extracted from the content of the draft message. In some embodiments, the properties of the draft message may also include the qualification of the sending user or respective intended recipients of the draft message, the size of one or more attachments included with the draft message, and a file type of one or more of the attachments included with the draft message.

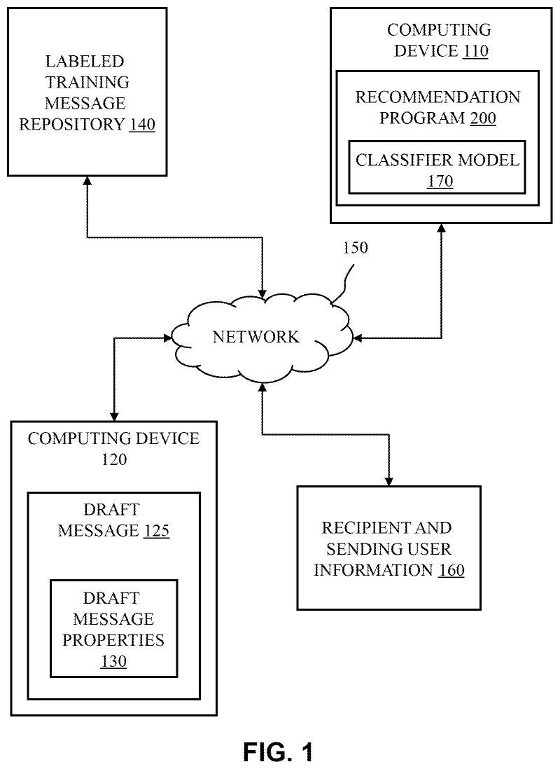

The present invention will now be described in detail with reference to the Figures. FIG. 1 is a functional block diagram illustrating a distributed data processing environment, generally designated 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

FIG. 1 depicts distributed data processing environment 100. Distributed data processing environment 100 includes computing device 110, computing device 120, draft message 125, draft message properties 130, corpus of labeled training message repository 140, and recipient and sending user information 160, all connected via network 150. Network 150 can be, for example, a local area network (LAN), a wide area network (WAN), such as the Internet, a virtual local area network (VLAN), or any combination that can include wired, wireless, or optical connections. In general, network 150 can be any combination of connections and protocols that will support communication and data transmission between computing device 110, computing device 120, corpus of labeled training message repository 140, and recipient and sending user information 160.

Computing device 110 includes communication classifier program 200, which includes classifier model 170 as a component module. Computing device 110 is depicted as communicably connected to computing device 120 on which a user of computing device 120, also referred to as a “sending user,” has authored a draft message. In some embodiments of the present invention, computing device 110 receives a draft message, such as draft message 125 received from computing device 120 via network 150. In an alternative embodiment, a user of computing device 110 authors a draft message that remains with computing device 110 and is internally submitted on computing device 110 to communication classifier program 200 (not shown).

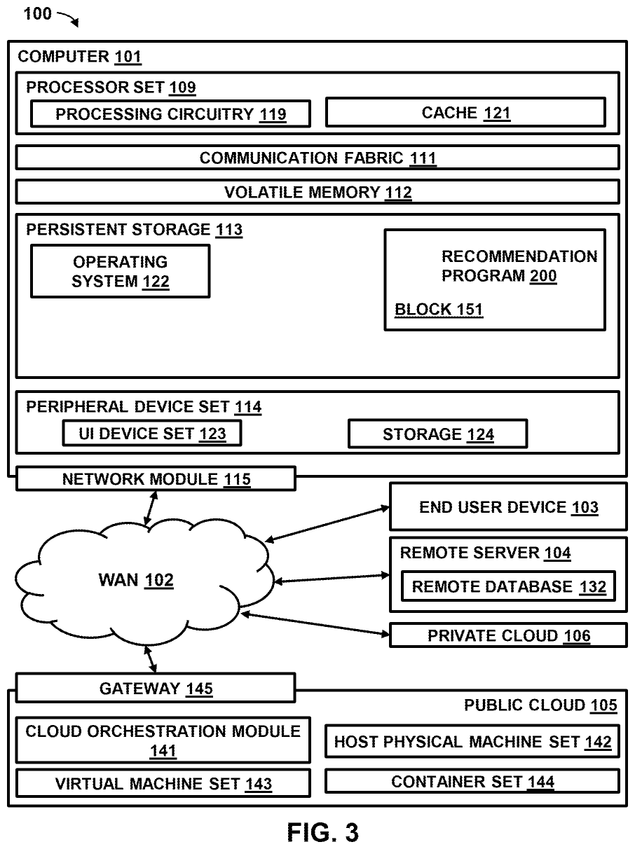

In some embodiments, computing device 110 can be a laptop computer, desktop computer, mobile computing device, smartphone, tablet computer, or other programmable electronic device or computing system capable of receiving, sending, and processing data. In other embodiments, computing device 110 may be a stand-alone computing device interacting with applications and services hosted and operating in a cloud computing environment. In still other embodiments, computing device 110 may be a blade server, web-based server computer, or be included in a computing system utilizing clustered computers and components (e.g., database server computers, application server computers, etc.) that act, respectively, as a single pool of seamless resources when accessed within distributed data processing environment 100. In yet other embodiments, computing device 110 can be a netbook computer, personal digital assistant (PDA), or other programmable electronic device capable of receiving data from and communicating with computing device 120, labeled training message repository 140, and recipient and sending user information 160. Computing device 110 may include internal and external hardware components, depicted in more detail in FIG. 3.

Communication classifier program 200 is depicted as operating on computing device 110. In other embodiments, communication classifier program 200 may be included and operate on computing device 120 (not shown). Communication classifier program 200 includes classifier model 170 as a functional module of communication classifier program 200. In some embodiments of the present invention, communication classifier program 200 receives a draft message from a sending user in which the draft message contains at least one property. Communication classifier program 200 extracts properties of the draft message in which the properties include the at least one intended recipient of the draft message, information about the sending user and the at least one recipient, a subject of the draft message, concepts within the content of the draft message, a sentiment of the draft message, and zero or more attachments included with the draft message. Communication classifier program 200 utilizes natural language processing (NLP) tools and semantic techniques to identify and extract the properties from the text of the draft message.

In some embodiments, the properties of the draft message further include a message history of at least one recipient with the sending user, an organizational relationship of at least one recipient with the sending user, a number of recipients, known qualification of at least one recipient or the sending user, the length of the draft message, concepts extracted from the draft message, a number of attachments to the draft message, a file type of at least one of the attachments to the draft message, and a size (i.e., word count, page count) of at least one attachment to the draft message. In some embodiments, communication classifier program 200 accesses one or more repositories, such as recipient and sending user information 160 depicted in FIG. 1, and determines properties of the draft message such as an organizational relationship (i.e., team member-team leader, manager-employee), a history of messages between the sender and one or more recipients (i.e., emails of the same or similar subject matter), and qualifications of the sender and/or one or more recipients (i.e., job position, certifications, degrees).

Communication classifier program 200 determines a classification of a mode of communication that is determined to be more appropriate and effective, given an analysis of the properties extracted from the draft message. The classification modes include a determination of a person-to-person meeting to be scheduled with the sending user and the intended recipients of the draft message or a delivery of the draft message as an electronic communication, such as an email, or a text message. The person-to-person meeting referred to herein, includes a physically, in-person meeting or an online conference meeting. The person-to-person meeting that communication classifier program 200 can recommend is scheduled, and includes synchronized communication (i.e., communication at the same time of the event of the meeting) of two or more invitees of the meeting in which participants can engage in back-and-forth discussion, ask questions or clarifications during the meeting. The delivered communication as referred to herein, is an electronic communication, such as an email or text message, and is a one-way asynchronous communication. The delivered communication does not offer opportunity for questions, clarifications, or back-and-forth discussion at the same time of delivery of the communication, and generally requires one or more response communication deliveries subsequent to the sending user's communication delivery from recipients, which may lead to several instances of responses, separated in time and independent of each respective response.

Communication classifier program 200 submits the extracted properties of the draft message to classifier model 170, which is a component module of communication classifier program 200 and has been pre-trained to receive the draft message properties, analyze the properties, and generate a recommendation of whether scheduling a person-to-person meeting is appropriate and would be more effective in addressing the subject and content of the draft message. In response to determining that the draft message is more appropriate to be addressed in the scheduled person-to-person meeting with the recipients of the draft message, communication classifier program 200 generates a recommendation and presents the recommendation to the sending user. In some embodiments, communication classifier program 200 includes an accept or reject option with the recommendation of the meeting, and in response to receiving an “accept” response from the sending user, communication classifier program 200 generates a recommended meeting notice that includes combinations of invitees (i.e., contact information from the draft message) meeting subject, a summary of content concepts, objectives if recited in the content, and related attachments indicated in the draft message.

For the case in which communication classifier program 200 does not recommend a meeting as appropriate to address the draft message, communication classifier program 200 may provide a “meeting not recommended” response, in which case the sending user may choose how else to proceed, or in some embodiments, communication classifier program 200 may provide a recommendation to proceed with the draft message in a communication delivery (i.e., email, text message(s), etc.).

Computing device 120 is depicted as including draft message 125, which further includes draft message properties 130. In some embodiments, computing device 120 is operated by a user, referred to herein as a “sending user”, who authors draft message 125. Computing device 120 is communicatively connected to computing device 110 via network 150, thus enabling draft message 125 to be sent to communication classifier program 200 operating on computing device 110. In an alternative embodiment, communication classifier program 200 may be installed and operating on computing device 120, and draft message 125 may be submitted to communication classifier program 200 directly (not shown).

Computing device 120 can be a laptop computer, desktop computer, mobile computing device, smartphone, tablet computer, or other programmable electronic device or computing system capable of receiving, sending, and processing data. In other embodiments, computing device 120 may be a stand-alone computing device interacting with applications and services hosted and operating in a cloud computing environment. In still other embodiments, computing device 120 may be a blade server, web-based server computer, or be included in a computing system utilizing clustered computers and components (e.g., database server computers, application server computers, etc.) that act, respectively, as a single pool of seamless resources when accessed within distributed data processing environment 100. In yet other embodiments, computing device 120 can be a netbook computer, personal digital assistant (PDA), or other programmable electronic device capable of sending and receiving data from and communicating with computing device 110. Computing device 120 may include internal and external hardware components, depicted in more detail in FIG. 3.

Draft message 125 is authored by a sending user as an operator of computing device 120. Draft message 125 includes an identification of a sending user, identification of one or more recipients of the draft message, the content of the draft message, and zero or more attachments included with the draft message. Draft message 125 includes additional properties of a message history of at least one recipient with the sending user, an organizational relationship of at least one recipient with the sending user, a number of recipients, known qualification of at least one recipient or the sending user, the length of the draft message, concepts extracted from the draft message, a number of attachments to the draft message, a file type of at least one of the attachments to the draft message, and a size (i.e., word count, page count) of at least one attachment to the draft message. Draft message 125 has been authored by the sending user but has not been delivered to any recipient and is in condition to submit to communication classifier program 200 operating on computing device 110 via network 150.

Draft message properties 130 represents components of draft message 125 that are extracted by communication classifier program 200 as properties of the draft message. Draft message properties include, but are not limited to, the identity of a sending user, the identities of the intended recipients of the draft message (i.e., contact information such as an email address), the number of recipients, message history between the sending user and recipients, message length, concepts within the content of the draft message, number of attachments, length of at least one of the attachments, file type of at least one attachment, a sentiment of the draft message, and information about the sending user and the recipients, which may include organizational relationships, job position/function, and qualifications.

Labeled training message repository 140 includes prepared messages as training data that have been labeled by experts in collaborative work and communication effectiveness, or a plurality of labeled messages from a set of message recipients that have demonstrated skills in collaboration and work efficiency. The training data of labeled training message repository 140 is submitted to communication classifier program 200, which identifies and extracts properties of the messages and submits the properties to classifier model 170 in supervised machine learning activities to train classifier model 170. In some embodiments, the draft message is submitted to classifier model 170 in addition to the extracted properties. The training data messages have been previously determined as to whether a scheduled person-to-person meeting is recommended as more effective to address the draft message. In some embodiments, a corpus of training data message properties from labeled training message repository 140 is submitted to classifier model 170. Classifier model 170 utilizes machine learning to develop rules based on combinations and conditions of the properties of messages that are labeled as more effectively addressed by a scheduled person-to-person meeting, and other messages labeled as more effectively addressed by delivery of an electronic communication. The machine learning training of classifier model 170 results in determining whether a recommendation of a scheduled person-to-person meeting is a more effective approach to address the draft message, based on the rules developed from combinations and conditions of the draft message properties.

In an embodiment of the present invention, the users labeling the training data have experience and anecdotal evidence (i.e., historical instances of messages pursued as a scheduled person-to-person meeting or a delivery of an electronic message, and the assessment of effectiveness of the mode of communication), of combinations and conditions of training data message properties that indicate a scheduled person-to-person meeting was, or was not, a more effective approach to address the message. For example, a draft message with few recipients that are determined to be peers and a message subject and content concepts consistent with historical messages exchanged may indicate a person-to-person meeting is appropriate. A draft message to multiple recipients from their supervisor without complexity in subject or message content may be recommended as a delivery of an electronic message. In another embodiment, a subject or content topic of a sensitive nature may be appropriate to address in a person-to-person scheduled meeting instead of communicating in writing. In another example, a draft message with an attachment and content concepts requesting approval may be recommended to address in an electronic communication delivery, whereas a subject or content concept of feedback and suggestions for an attached document may require a scheduled person-to-person meeting to be effective and efficient.

Recipient and sending user information 160 is depicted as a repository of information about the recipients of the draft message and the sending user of the draft message. Collection and storage of data and information included in recipient and sending user information 160 has been agreed to by the sending user and the recipients of draft messages, having “opted-in”. In some embodiments, recipient and sending user information 160 may include multiple data sources about the sending user and recipients, all of which are accessible by communication classifier program 200 via network 150. Recipient and sending user information 160 includes but is not limited to a message history of the respective recipient and the sending user, an organizational relationship between respective recipients with each other and the sending user, job titles and/or job functions of the sending user and recipients of the draft message, qualifications associated with the sending user and the respective recipients, and sentiments of the message history of the sending user and respective recipients. In some embodiments, the labeling of training message data used to pre-train classifier model 170 is performed by communication and collaborative work experts, or training data of a plurality of messages have been labeled by a set of message recipients that have demonstrated skill in collaboration and work efficiency.

Classifier model 170 receives the extracted draft message properties 130 of draft message 125 and generates a recommendation of whether a scheduled person-to-person meeting with the intended recipients of the draft message is more appropriate to address the draft message. Classifier model 170 is pre-trained by using message properties extracted from labeled training message repository 140 in supervised machine learning activity. Classifier model 170 learns rules based on the combinations and conditions of message properties that are applied to generate a recommendation of whether a draft message is more appropriate to address in a scheduled, person-to-person meeting. Rules used to generate recommendations may consider the number of recipients, the length of the message, and the presence or absence of attachments as a combination, for example, but may also determine a condition of organizational relationships between recipients and the sending user, or the presence or absence of message history relating to the subject or concepts within the content of the draft message, for example. Conditions may also apply to job titles/positions and qualifications and certifications of the sending user and one or more recipients. Classifier model 170, for example, may learn and apply a rule that does not recommend a meeting to address a draft message if there are multiple recipients with a brief message content indicating awareness with no attachments; however, classifier model 170 may learn that a condition of message history between the sending user and recipients indicates a back-and-forth exchange of the same subject, indicating an unresolved issue, and therefore recommend a meeting as a rule that includes the determined condition.

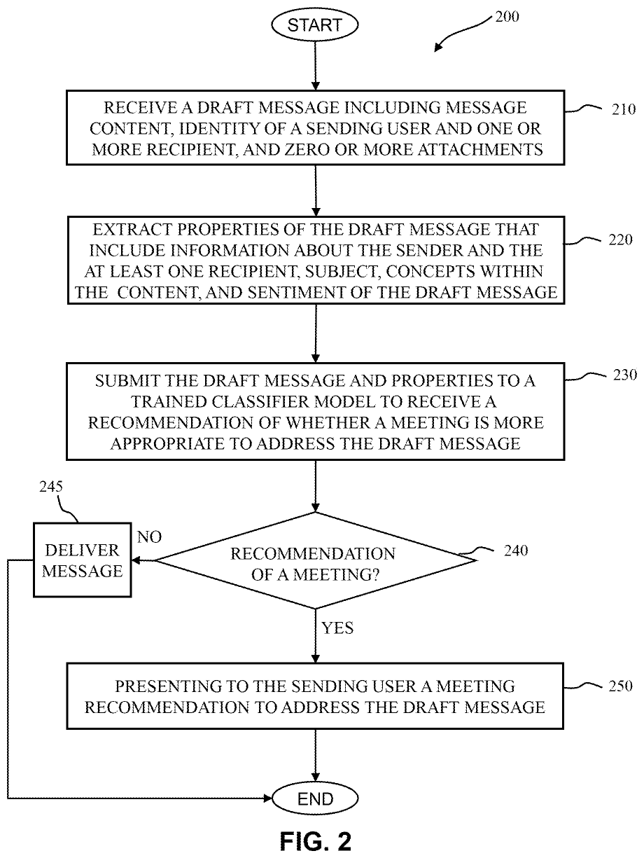

FIG. 2. is a flowchart depicting the operational steps of communication classifier program 300, in accordance with an embodiment of the present invention. Communication classifier program 200 includes classifier model 170 which is pre-trained by machine learning techniques as a component module that determines a recommendation of whether a meeting is a more appropriate means to address a draft message.

Communication classifier program 200 receives a draft message including message content, an identity of a sending user and at least one recipient, and zero or more attachments (step 210). Communication classifier program 200 receives a draft message from a “sending user,” which has not been delivered to the intended recipients. The draft message includes the content of the message, the identity of the sending user and at least one recipient, and zero or more attachments. In some embodiments, the draft message is authored on a computing device operated by the sending user and sent to a second computing device on which communication classifier program 200 operates. In another embodiment, the draft message is authored on the same computing device on which communication classifier program 200 operates.

For example, a sending user operating computing device 120 authors draft message 125 that includes draft message properties 130 and sends the draft message via network 150 to computing device 110. Draft message 125 is received by communication classifier program 200 operating on computing device 110.

Communication classifier program 200 extracts properties of the draft message that include information about the sending user and the at least one recipient, the subject of the draft message, concepts within the content, and a sentiment of the draft message (step 220). In some embodiments, communication classifier program 200 applies natural language processing (NLP) and semantic analysis techniques to identify and extract properties of the draft message. Communication classifier program 200 identifies and determines information associated with the sending user and recipients, which the sending user and recipients have “opted-in” for granting access to the information. In some embodiments, obtaining the information associated with the sending user and the recipients of the draft message includes extracting information from one or more repositories that include organizational relationships, communication, message history, position and/or title, and qualifications and certifications, of the sending user and the recipients of the draft message. In some embodiments, communication classifier program 200 extracts additional information associated with the draft message, including but not limited to, the subject of the draft message, the concepts within the content of the draft message, the length of the draft message, the sentiment of the draft message, the number of attachments included with the draft message, and the length of at least one attachment of the draft message.

For example, communication classifier program 200 accesses information from recipient and sending user information 160 which, in some embodiments may include multiple repositories of information. Communication classifier program 200 determines and extracts the organizational relationships that the sending user and the recipients who are in the same department and extracts titles and areas of expertise of one or more recipients. Communication classifier program 200 extracts the draft message subject, the concepts of the message content, a sentiment indicating urgency, and determines the message length as well as identifying two attachments associated with the draft message.

Communication classifier program 200 submits the draft message and properties to a trained classifier model to receive a recommendation on whether scheduling a meeting is more appropriate to address the draft message (step 230). Communication classifier program 200 submits the extracted draft message properties to classifier model 170, which functions as a component module of communication classifier program 200. Classifier model 170 is pre-trained by supervised machine learning techniques in which a corpus of messages is submitted to classifier model 170 as training data, which are labeled to indicate a recommendation of addressing the message in a meeting or by a delivered communication. In some embodiments, the labeling of the training data messages is done by experts in collaborative work and communication effectiveness. Classifier model 170 learns rules related to determining a recommendation, based on the labeled training data messages. Classifier model 170 considers combinations and conditions of the draft message properties in generating a recommendation of whether a meeting is more appropriate to address the subject and content of the draft message.

Communication classifier program 200 determines a recommendation (decision step 240). Communication classifier program 200, through the analysis of classifier model 170, considers rules developed from the pre-training by supervised machine learning and considers the combinations of properties extracted from the draft message to determine a recommendation of whether a meeting with the recipients of the draft message is a more appropriate manner in which to address the draft message or whether delivery of a communication of the message is adequate.

For the case in which communication classifier program 200 determines a recommendation that a meeting is not appropriate to address the draft message (step 240, “NO” branch), communication classifier program 200 presents a recommendation to not address the draft message by inviting the recipients to a meeting. In some embodiments, communication classifier program 200 may provide the sending user a recommendation stating that the “meeting is not recommended.” In other embodiments, communication classifier program 200 may present a recommendation to deliver the draft message to the recipients in a communication (step 245). In some embodiments, communication classifier program 200 may present other alternative recommendations in which a meeting to address the draft message is not recommended or present no recommendation at all.

For the case in which communication classifier program 200 determines a recommendation that a meeting with the recipients of the draft message is appropriate to address the draft message (step 240, “YES” branch), communication classifier program 200 proceeds to present to the sending user a recommendation for a meeting to address the draft message (step 250). In some embodiments, communication classifier program 200 recommends that the meeting include the recipients of the draft message. In some embodiments, communication classifier program 200 delivers the recommendation as a text message or an audio message to the computing device of the sending user. In other embodiments, communication classifier program 200 converts the draft message into a meeting invitation that can be distributed by the sending user.

In some embodiments, the recommendation includes an accept or decline option for the sending user (not shown), and in response to the sending user accepting the recommendation of addressing the draft message in a meeting with the recipients of the draft message, communication classifier program 200 generates a recommended meeting notice for the draft message meeting. The generated meeting notice includes but is not limited to the communication contact information of the recipients from the draft message, the subject of the meeting, a summary or listing of the concepts extracted from the draft message content, objectives of the meeting if indicated in the draft message, and the zero or more attachments included with the draft message. Communication classifier program 200 presents the recommended meeting notice to the sending user.

FIG. 3 depicts a schematic illustration of exemplary network resources associated with practicing the disclosed inventions. The inventions may be practiced by the disclosed processors performing an instruction stream. As shown in FIG. 3, computing environment 100 contains an example of an environment for the execution of at least some of the computer code involved in performing the inventive methods, such as the method of communication classifier program 200 in block 151, retained in persistent storage 113. In addition to block 151, computing environment 100 includes, for example, computer 101, wide area network (WAN) 102, end-user device (EUD) 103, remote server 104, public cloud 105, and private cloud 106. In this embodiment, computer 101 includes processor set 109 (including processing circuitry 119 and cache 121), communication fabric 111, volatile memory 112, persistent storage 113 (including an operating system 122 and communication classifier program 200 of block 151, as identified above), peripheral device set 114 (including user interface (UI), device set 123, storage 124, and network module 115. Remote server 104 includes remote database 132. Public cloud 105 includes gateway 145, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer, or any other form of computer or mobile device now known or to be developed in the future that is capable of running a program, accessing a network or querying a database, such as remote database 132. In some embodiments, computer 101 may take the form of a hand-held device capable of receiving audible input and transmitting a converted radio signal of the audible input to other similarly configured devices set to receive the transmitted signal on the same subchannel of a communication channel. As is well understood in the art of computer technology, and depending upon the technology, the performance of a computer-implemented method may be distributed among multiple computers and/or between multiple locations. On the other hand, in this presentation of computing environment 100, a detailed discussion is focused on a single computing device, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated. In some embodiments, computing device 110 is similar to computer 101.

PROCESSOR SET 109 includes one, or more, computer processors of any type now known or to be developed in the future. Processing circuitry 119 may be distributed over multiple packages, for example, multiple, coordinated integrated circuit chips. Processing circuitry 1119 may implement multiple processor threads and/or multiple processor cores. Cache 121 is a memory that is located in the processor chip package(s) and is typically used for data or code that should be available for rapid access by the threads or cores running on processor set 109. Cache memories are typically organized into multiple levels depending upon relative proximity to the processing circuitry. Alternatively, some, or all, of the cache for the processor set may be located “off-chip.” In some computing environments, processor set 109 may be designed for working with qubits and performing quantum computing.

Computer readable program instructions are typically loaded onto computer 101 to cause a series of operational steps to be performed by processor set 109 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 109 to control and direct the performance of the inventive methods. In computing environment 100, at least some of the instructions for performing the inventive methods may be stored in communication classifier program 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that are now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code in the representative block 151 includes communication classifier program 200, which typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. In some embodiments of the present invention, EUD 103 may be computing device 120, configured to author draft message 125. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 132 of remote server 104. Remote database 132 may represent one or more databases that include labeled training message repository 140 and recipient and sending user information 160.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after the instantiation of the VCE. Cloud orchestration module 141 manages the transfer and storage of images, deploys new instantiations of VCEs, and manages active instantiations of VCE deployments. Gateway 145 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors.

Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The programs described herein are identified based on the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus, or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor, from a sending user, a draft message intended for at least one recipient;
extracting, by the processor, at least one property of the draft message using natural language processing (NLP) and semantic analysis;
submitting, by the processor, the at least one property of the draft message to a classifier model pre-trained to recommend whether a scheduled person-to-person meeting with the at least one recipient will be more effective to address the draft message; and
responsive to receiving a recommendation from the pre-trained classifier model to address the draft message in the scheduled synchronous meeting with the at least one recipient, presenting, by the processor, the recommendation to the sending user.

2. The computer-implemented method of claim 1, wherein the at least one property of the draft message includes at least one of identities of the sending user and the at least one recipient, a subject of the draft message, concepts within the content, a length of the draft message, a number of attachments, a length of one of the attachments, a file type of at least one attachment, message history of the sending user and the at least one recipient, organizational relationships of the sending user and intended recipients, job function of one or more of the sending user and the at least one recipient, and sentiment of the draft message.

3. The computer-implemented method of claim 1, further comprising:
responsive to receiving the recommendation for the meeting to address the draft message, converting, by the processor, the draft message into a meeting invitation, wherein the meeting invitation is for an in-person or a virtual meeting event.

4. The method of claim 1, further comprising:
responsive to an absence of receiving the recommendation of a scheduled person-to-person meeting with the at least one recipient of the draft message, presenting, by the processor, to the sending user, an alternative recommendation to deliver the draft message in an electronic communication to the at least one recipient.

5. The computer-implemented method of claim 1, further comprising:
submitting, by the processor, a corpus of messages to the classifier model; and
training, by the processor, the classifier model utilizing supervised machine learning techniques applied to the corpus of messages that are labeled by users with expertise in collaborative work and communication effectiveness.

6. The computer-implemented method of claim 1, wherein the at least one property includes a subject of the draft message, a message history of the sending user and the at least one recipient, the length of the draft message, and a sentiment of the draft message.

7. The computer-implemented method of claim 1, further comprising:
responsive to determining the draft message is not recommended to address in the meeting with the at least one recipient of the draft message, delivering, by the processor, the draft message to the at least one recipient of the draft message in an electronic communication.

8. A computer system, comprising:
one or more computer processors;
at least one computer-readable storage medium;
program instructions stored on the at least one computer-readable storage medium, the program instructions comprising:
program instructions to receive from a sending user, a draft message that includes at least one recipient;
program instructions to extract at least one property of the draft message using natural language processing (NLP) and semantic analysis;
program instructions to submit the at least one property of the draft message to a classifier model trained to recommend whether a scheduled person-to-person meeting with the at least one recipient is more appropriate to address the draft message; and
responsive to receiving a recommendation from the pre-trained classifier model to address the draft message in the meeting with the at least one recipient, program instructions to present the recommendation to the sending user.

9. The computer system of claim 8, wherein the at least one property of the draft message includes at least one of identities of the sending user and the at least one recipient, a subject of the draft message, concepts within the content, a length of the draft message, a number of attachments, a length of one of the attachments, a file type of at least one attachment, message history of the sending user and the at least one recipient, organizational relationships of the sending user and the at least one recipient, job function of the sending user and the at least one recipient, and sentiment of the draft message.

10. The computer system of claim 8, further comprising:
responsive to receiving the recommendation for the meeting to address the draft message, program instructions to convert the draft message into a meeting invitation, wherein the meeting invitation is for an in-person or a virtual meeting event.

11. The computer system of claim 8, further comprising:
responsive to and absence of a received recommendation for a scheduled person-to-person meeting with the at least one recipient of the draft message, program instructions to present to the sending user, an alternative recommendation to deliver the draft message in a communication to the recipients.

12. The computer system of claim 8, further comprising:
program instructions to submit a corpus of messages to the classifier model; and
program instructions to train the classifier model utilizing supervised machine learning techniques applied to the corpus of messages that are labeled by users with expertise in collaborative work and work interactions.

13. The computer system of claim 8, wherein the at least one property includes a subject of the draft message, a message history of the sending user and the at least one recipient, a length of the draft message, and a sentiment of the draft message.

14. The computer system of claim 8, further comprising:
responsive to determining the draft message is not recommended to address in the meeting with the at least one recipient of the draft message, program instructions to deliver the draft message to the at least one recipient of the draft message in an electronic communication.

15. A computer program product, comprising:
at least one computer-readable storage medium and program instructions stored on the at least one computer-readable storage medium, the program instructions comprising:
program instructions to receive from a sending user, a draft message intended for at least one recipient;
program instructions to extract at least one property of the draft message using natural language processing (NLP) and semantic analysis;
program instructions to submit the at least one property of the draft message to a classifier model trained to recommend whether scheduling a meeting with the at least one recipient is more appropriate to address the draft message; and
responsive to receiving a recommendation from the pre-trained classifier model to address the draft message in the meeting with the recipients, program instructions to present the recommendation to the sending user.

16. The computer program product of claim 15, wherein the at least on property of the draft message includes at least one of identities of the sending user and the at least one recipient, a subject of the draft message, concepts within the content, a length of the draft message, a number of attachments, a length of one of the attachments, a file type of at least one attachment, message history of the sending user and the at least one recipient, organizational relationships of the sending user and intended recipients, job function of the sending user and the at least one recipient, and sentiment of the draft message.

17. The computer program product of claim 15, further comprising:
responsive to receiving the recommendation for the meeting to address the draft message, program instructions to convert the draft message into a meeting invitation, wherein the meeting invitation is for a scheduled, in-person or a virtual meeting event.

18. The computer program product of claim 15, further comprising:
responsive to not receiving the recommendation of a meeting with the at least one recipient of the draft message, program instructions to present to the sending user, an alternative recommendation to deliver the draft message in a communication to the recipients.

19. The computer program product of claim 15, further comprising:
program instructions to submit a corpus of messages to the classifier model, wherein the corpus of messages is labeled as more effective to be addressed in a scheduled person-to-person meeting or by sending an electronic communication; and
program instructions to train the classifier model utilizing supervised machine learning techniques applied to the corpus of messages that are labeled, wherein the users labeling the corpus of messages have expertise in collaborative work interactions.

20. The computer program product of claim 15, further comprising:
responsive to determining the draft message is not recommended to address in a meeting with the recipients of the draft message, program instructions to deliver the draft message to the at least one recipient of the draft message in an electronic communication.
